(19) United States
(12) Patent Application Publication
(10) Pub. No.: US 2006/0273253 A1
(43) Pub. Date: Dec. 7, 2006

(54) Pseudo-random binary sequence gate-switching for spectrometers

(76) Inventors: John Patrick Fitzgerald, Hertfordshire (GB); Bruce Alec Colin Grant, Finchley (GB); Basil Polychronopulos, Bedfordshire (GB)

Correspondence Address: FOLEY AND LARDNER LLP;SUITE 500, 3000 K STREET NW, WASHINGTON, DC, 20007, US

(21) Appl. No.: 10/553,417

(22) PCT Filed: Apr. 28, 2004
(86) PCT No.: PCT/GB04/01816

§ 371 Date: Oct. 17, 2005

(30) Foreign Application Priority Data
Apr. 30, 2003 (GB) 0309900.9

(51) Int. Cl. H01J 49/00

(52) U.S. Cl. 250/287

(57) ABSTRACT

An IMS or other detection system has an entry gate (3) controlled by a pseudo-random binary sequence that is bit-flipped to reduce noise. Matrix algebra is used to carry out deconvolution and analysis of the cell output.

This invention relates to detection systems of the kind including a detection cell having an entry gate, the system including drive means for controlling switching of the gate.

IMS systems are often used to detect substances such as explosives, drugs, blister and nerve agents or the like. An IMS system typically includes a detector cell to which a sample of air containing a suspected substance is supplied as a gas or vapour. The cell operates at atmospheric pressure and contains electrodes that are energized to produce a voltage gradient across the cell. Molecules in the sample of air are ionized, such as by means of a radioactive source or by corona discharge, and are admitted into the drift region of the cell by an electrostatic gate at one end. The ionized molecules drift to the opposite end of the cell at a speed dependent on the size of the molecule. By measuring the time of flight across the cell it is possible to identify the ion. Entry of ions into the drift region is usually controlled by a Bradbury Nielson gate. This consists of two sets of parallel electrically-conducting wires spaced from one another by gaps. The electric potential between the two sets of wires is switched between two different, discrete voltages so that the gate either allows ions to enter the drift region or prevents them.

It has been proposed in GB 2300296 that a temporal switching signature with ion admission of approximately 50% be applied to the gate and a Fourier transformation technique be used to obtain the ion mobility spectrum. We are not aware to date of any IMS system being sold that employs this technique. This may be because the effect of noise on the signal makes it difficult to achieve good results.

It is an object of the present invention to provide an alternative IMS system.

According to one aspect of the present invention there is provided a detection system of the above-specified kind, characterised in that the drive means is arranged to control switching of the gate in a pseudo-random binary sequence.

The pseudo-random binary sequence is preferably bit-flipped to reduce noise. The output is preferably analysed by matrix algebra. The system may be arranged to carry out deconvolusion on the cell output using matrix algebra. The system may be an IMS detection system and the cell may have a drift region, the gate being arranged to control entry to the drift region.

According to another aspect of the present invention there is provided a method of controlling switching of an admittance gate in a detection system, characterised in that the gate is switched in a pseudo-random binary sequence.

Preferably the pseudo-random binary sequence is bit-flipped. The method preferably includes analysing an output using matrix algebra. The method may include deconvolution of the output using matrix algebra.

An IMS system according to the present invention, will now be described, by way of example, with reference to the accompanying drawings, in which:

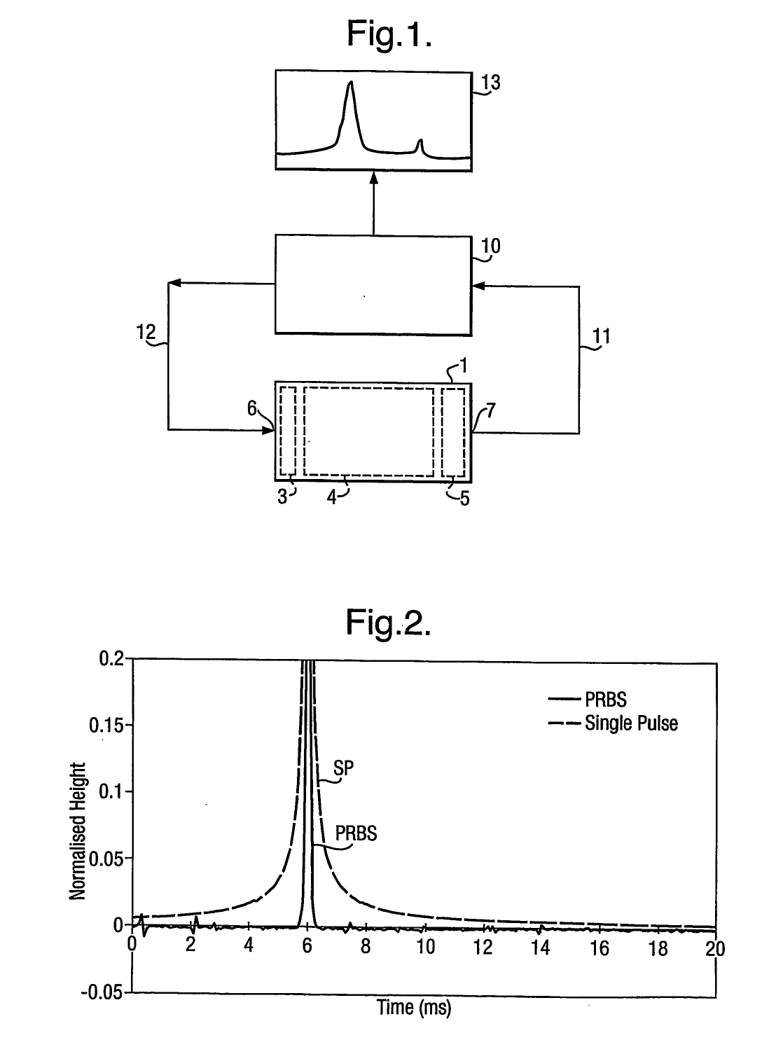

FIG. 1 is a schematic diagram of the system;

FIG. 2 is a graph comparing a PRBS autocorrelation peak with a normal spectrum peak;

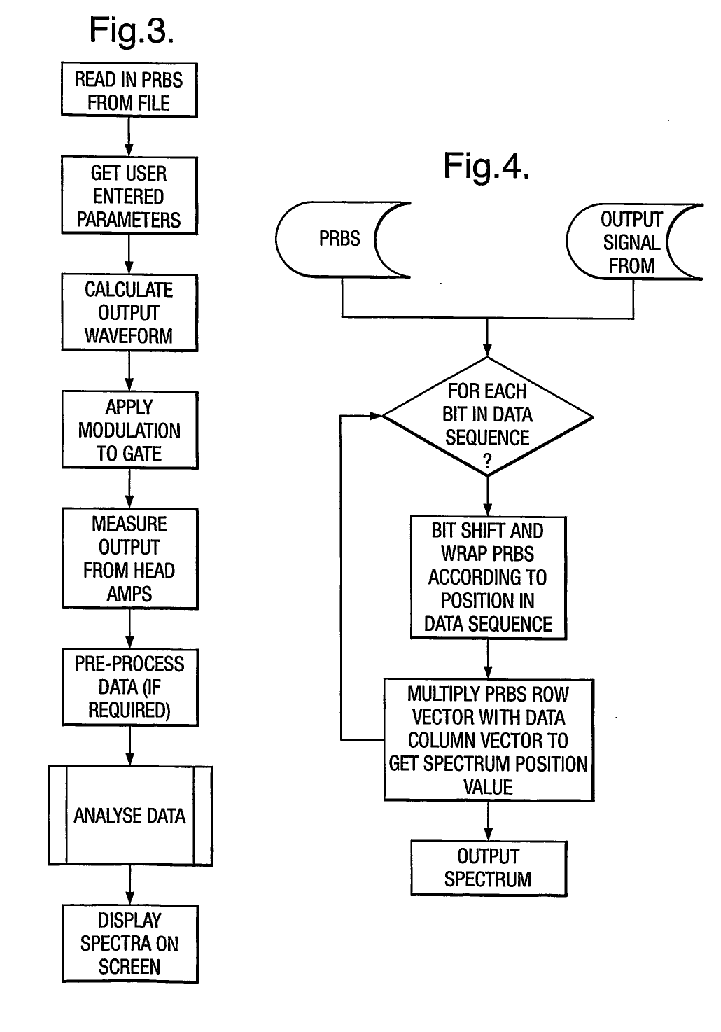

FIG. 3 is a flow diagram of the PRBS operating mode;

FIG. 4 is a flow diagram of the PRBS data analysis method;

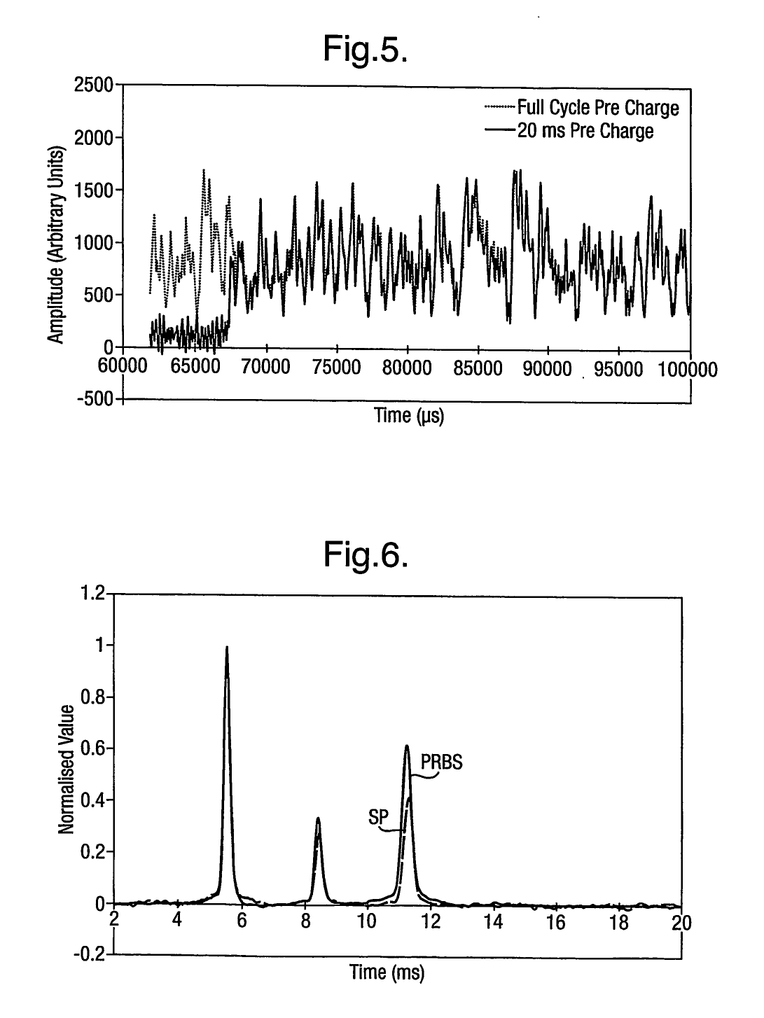

FIG. 5 is a graph of raw PRBS data for a full cycle pre-charge and for a 20 ms pre-charge; and

FIG. 6 is a graph comparing the normalised spectra of DPM in the PRBS and normal modes.

With reference first to FIG. 1, the system includes an IMS drift cell 1 with an ion admittance gate 3, a drift region 4 and an ion receiving head 5. The gate 3 includes drive electronics and a power supply capable of functioning at relatively high duty cycle modulation rates. The cell 1 has an input 6 for controlling operation of the gate 3, and an output 7 for the amplified output of the receiving head 5. A computer 10 receives on line 11 the output from the head amplifier and also supplies control signals via line 12 to the gate control input 6. The computer 10 performs an analysis on the input signals to provide an ion mobility spectrum output to a display, alarm or other utilisation means 13.

The computer 10 controls switching of the gate 3 by switching it on (1) to enable admission of ions to the drift chamber 4, or switching it off (0) to prevent flow of ions. The series of 1s and 0s follows a pseudo random binary sequence (PRBS). The preferred PRBS is a “maximal length sequence”, which is readily generated using linear feedback shift registers or in software. Alternatively, the PRBS could be a “quadratic residue sequence”.

The PRBS modulated output from the cell 1 can be analysed in two different ways. The data can be analysed in the frequency domain with Fourier Transform techniques or it can be analysed directly in the time domain using matrix algebra. Both techniques have been found to give similar results but the matrix algebra technique is preferred because it requires less computation power.

The matrix algebra technique involves constructing a square analyser matrix S, with the same dimension as the input data column matrix D, in which the top row is the applied PRBS. Each successive row of S is formed by taking the previous row, shifting it one place to the right and wrapping the end back onto the beginning. The output spectrum Z expressed as a column matrix is obtained from the input matrix D by simple matrix multiplication:
Z=S·D

The PRBS modulation enables multiple pulses to be averaged in significantly less time than would be required to average multiple single shots. A PRBS of length n would be expected to give an improvement in signal-to-noise ratio of √n/√2 over single shot data collection using the same pulse length, given that a sequence of length n effectively contains n/2 pulses.

If the 0s in the original PRBS were replaced with −1s then, for the corresponding sequence of 1s and −1s, the associated improvement in signal-to-nose ratio would be √n.

Such a sequence cannot be achieved directly in an IMS system because there is no way to reverse ion flow. It can, however, be achieved by combining two appropriate sequences.

For example, if S and S_{β} are the analysing matrices corresponding to the original and bit-flipped PRBSs respectively, D and D_{β} are the corresponding data sets obtained from the system for each modulation set and N is the superimposed set of systematic noise data, assumed to be the same for each modulation sequence, then the following identities can readily be verified:
D_{β}=I_{c}−D
S_{β}=Iₛ−S
where I_{c} and Iₛ are unit matrices of appropriate dimensions and, in the presence of systematic noise represented by column matrix N, the following four analysis sets can be defined:
Z₁₁=S.(D+N)
Z_{1β}=S.(D_{β}+N)
Z_{β1}=S_{β}.(D+N)
Z_{ββ}=S_{β.}(D_{β}+N)
These can be combined to give:

$$\begin{matrix}Z = {Z}_{11} + {Z}_{ββ} - {Z}_{1 β} - {Z}_{β 1} \\ = S \cdot ( D + N ) + S \cdot ( {D}_{β} + N ) - S \cdot ( {D}_{β} + N ) - {S}_{β} \cdot ( D + N ) \\ = ( S - {S}_{β} ) \cdot ( D + N ) - ( S - {S}_{β} ) \cdot ( {D}_{β} + N ) \\ = ( S - {I}_{s} + S ) \cdot ( D + N - {I}_{c} + D - N ) \\ = ( 2 S - {I}_{s} ) \cdot ( 2 D - {I}_{c} ) \\ = 4 S \cdot D + const\end{matrix}$$

this has an autocorrelation peak of height N (sequence length N) with a baseline of −1, thus removing systematic noise from the processed spectrum.

The PRBS modulation provides improved resolution over single shot data collection methods for several reasons. First, the shorter gate opening times give improved resolution with a more precisely defined packet of ions. The width of the sequence autocorrelation peak is equal to the narrowest pulse in the sequence. To minimize electronic noise in the system, the system frequency response is matched to the frequency spectrum of the detected pulses. Shorter pulses require higher bandwidths leading to inherently more electronic noise. For fixed ion currents, shorter pulses with matching system bandwidths result in improved resolution but with a reduced signal-to-noise ratio. If the bandwidth of the system is reduced to reduce the noise, the detected pulse will be spread and reduced in amplitude. This negates the improved resolution

Fourier analysis, however, shows that a long sequence of shorter pulses does not impose additional bandwidth requirements on the electronics of the system so higher resolutions can be achieved without any reduction in the signal-to-noise ratio. This is illustrated in FIG. 2 where the spectrum of a single pulse is indicated by the curve marked SP and that of a PRBS system is indicated by the curve marked PRBS using a conventional receiving head amplifier and filters. The single pulse has a width of 80 μs and the PRBS signal has a length of 2047 and a bit width of 80 μs. It can be seen that the PRBS has a significantly better resolution.

The computer 10 is preferably also arranged to carry out deconvolution in order to enhance resolution. It is well known that this can be carried out in the frequency domain but it is also possible directly in the time domain using matrix algebra

If P is the column matrix representing the observed spectrum and P1 is the column matrix representing the un-spread spectrum then:
P=A.P1
where A is a square matrix comprising the spreading function.

In practice, A is a wrapped matrix like the PRBS analysing matrix where each row is the same as the one above but moved one place to the right and wrapped back on itself. Therefore:
A⁻¹.P=A⁻¹.A.P1=P1
where A⁻¹ is the inverse of the matrix A, also a wrapped matrix.

The computer performs deconvolution on the observed spectrum from knowledge of the spreading function, which is used to form a wrapped square matrix, and which is then inverted.

FIGS. 3 and 4 are flow diagrams illustrating the main processes involved in obtaining spectra using PRBS modulation. The upper two boxes in FIG. 3 show the reading of the chosen PRBS from a data file and its use together with additional parameters entered by the user, such as bit width, to generate the output waveform. This output is then applied to the gate 3 and the resulting signal from the head amplifiers 5 are then recorded by the computer 10. The collected data is then pre-processed, if required, such as by subtracting one data set from another, before being analysed. Details of the analysis activity are shown in FIG. 4, the collected data from the head amplifiers 5 as a column vector is multiplied with the PRBS as a row vector to produce a single data point in the output spectrum. The PRBS is then “bit shifted” and “wrapped” one place and the process repeated to generate the remaining points in the output spectrum.

The PRBS technique is essentially continuous, the sequence repeating when it reaches its end point. For this reason, it is pre-charged with the final 20 ms of the PRBS to get the ions and data into the system before beginning the analysis. Typically, the system is allowed to run through the entire PRBS twice and only the repeated sequence is analysed.

FIG. 5 shows typical raw data collected from a PRBS-modulated IMS cell using a PRBS of length 2047 and a bit length of 40 μs, giving a total time of just over 80 ms. The broken line shows the end of one full cycle followed by the start of a second. The solid line trace consists of the final 20 ms of the PRBS appended to the front of it to pre-charge the part of the spectrum of interest.

FIG. 6 shows the normalized spectra for the substance DPM (dipropylene glycol monomethyl ether) produced using conventional averaged single-pulse techniques, as shown by the trace labelled “SP”, and using PRBS techniques, as shown by the trace labelled “PRBS”. It can be seen that the spectrum produced by the PRBS technique produces a noticeably higher amplitude for two of the three main peaks.

The present invention can be used to enable detection systems to be provided with improved signal-to-noise and enhanced resolutions compared with conventional techniques. The invention is not limited to IMS detection systems but could be used in other detection systems, such as, time-of-flight mass spectrometry, fourier transform mass spectrometry, fourier transform ion cyclotron resonance, fourier transform infra-red spectrometry and fourier transform nuclear magnetic resonance.

1. A detection system including a detection cell having an entry gate, the system including drive means for controlling switching of the gate, wherein the drive means is arranged to control switching of the gate in a pseudorandom binary sequence.

2. A detection system according to claim 1, wherein the pseudo-random binary sequence is bit-flipped to reduce noise.

3. A detection system according to claim 1, wherein the output is analysed by matrix algebra.

4. A detection system according to claim 1, wherein the system is arranged to carry out deconvolution on the cell output using matrix algebra.

5. An 1 MS detection system according to claim 1, wherein the cell has a drift region and that the gate is arranged to control entry to the drift region.

6. A method of controlling switching of an admittance gate in a detection system, wherein the gate is switched in a pseudo-random binary sequence.

7. A method according to claim 6, wherein the pseudo-random binary sequence is bit-flipped.

8. A method according to claim 6, wherein the method includes analyzing an output using matrix algebra.

9. A method according to claim 6, wherein the method includes deconvolution of the output using matrix algebra.
